(19) United States
(12) Patent Application Publication
(10) Pub. No.: US 2025/0298660 A1
(43) Pub. Date: Sep. 25, 2025

(54) Batch Job Management System

(71) Applicant: Capital One Services, LLC, McLean, VA (US)

(72) Inventors: Kirit Nimdia, Henrico, VA (US); Girija Rao, Vienna, VA (US); Nitin Goel, Glen Allen, VA (US); Balasubrahmanya Balakrishna, Glen Allen, VA (US); Anjal Shah, Glen Allen, VA (US); Kapil Gupta, Glen Allen, VA (US); Sweta Tiwary, Basking Ridge, NJ (US)

(21) Appl. No.: 19/084,246

(22) Filed: Mar. 19, 2025

Related U.S. Application Data
(60) Provisional application No. 63/567,684, filed on Mar. 20, 2024.

(51) Int. Cl. G06F 9/48; G06F 9/52

(52) U.S. Cl. CPC G06F 9/4881; G06F 9/52

(57) ABSTRACT

Methods, systems, and apparatuses are described herein for managing execution of a multi-step batch job across different servers. A server may identify a batch job and query a persistent location to determine whether a job completion file for that batch job exists. If not, the server may determine whether each of a plurality of steps of the batch job have been completed and identify one or more steps to perform. As part of the performance of those one or more steps, the server may determine whether one or more lock marker files for one or more files exist. For instance, based on such lock marker files not existing, the server may generate a lock marker file for a file, process the file, and then delete the lock marker file after processing. A job completion file may then be stored to indicate completion of the batch job.

### CROSS-REFERENCE TO RELATED APPLICATIONS

This application is a non-provisional application claiming priority to U.S. Application Ser. No. 63/567,684, filed Mar. 20, 2024, which is hereby incorporated by reference in its entirety.

### FIELD OF USE

Aspects of the disclosure relate generally relate to server processing of batch jobs. More specifically, aspects of the disclosure may provide for management of the performance of batch jobs by multiple servers.

### BACKGROUND

In the context of multi-region server architectures, an active-active configuration may denote a setup where applications across multiple regions operate simultaneously and independently to process batch jobs. This intentionally redundant setup ensures continuity of service, as it ensures that a batch job might be performed even if one or more servers may become unavailable. For example, if the batch job entails processing user image uploads to generate different resolutions of the same image, then a redundant setup might ensure that those different resolutions of the same image are generated even if whole portions of a network become unavailable (e.g., due to a local Internet outage or the like). In this manner, it may be desirable to implement such redundancy to ensure continuity of service.

One problem with such a redundant setup is that it can be extremely difficult to manage the performance of different steps of a batch job, particularly when one step might be performed by one server and another step might be performed by an entirely different server. For instance, if different servers run on different operating systems and/or file systems, then those servers might take very different approaches to accessing/processing files, logging their activity, and the like. Pragmatically speaking, organizations often are not able to ensure that such servers are identical, meaning that this problem cannot simply be solved by creating replicas of the exact same server infrastructure across different regions. Worse still, it is very common that even remarkably similar servers attempt to perform the same processes at the same time, causing file access conflicts and causing the wasteful use of computing resources.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein relate to managing execution of multi-step batch jobs. As will be detailed with more particularity below, this approach may comprise, among other things, a process whereby batch job status management (including the tracking of batch job retries) is implemented, and may involve the use of unique files that can be stored on persistent locations (e.g., databases, data stores) and are used to evidence access to files and/or the performance of specific batch job steps by servers. In this manner, aspects described herein enable a wide variety of servers—including differently-configured servers, such a those using different file systems, operating systems, those operating in different time zones, and the like—the ability to collaborate on batch jobs simultaneously or at different times.

More particularly, a server may be configured to identify, via a queue of batch jobs performable by a plurality of different servers that includes the server, a batch job comprising a plurality of steps. For example, the server might identify a batch job (e.g., processing of user login data to identify trends) and a variety of steps corresponding to that batch job (e.g., generate master table of login records across various websites, process the master table to standardize data such as login times and other data, then generate an analysis file indicating login trends over time). The server may then query a persistent location to determine whether a job completion file corresponding to the batch job is stored on the persistent location and, based on determining that the job completion file corresponding to the batch job is not stored on the persistent location, determine whether each of the plurality of steps have been completed. Based on determining that each of the plurality of steps have not been completed, the server may identify one or more steps of the plurality of steps to perform. In some cases, one or more steps might have already been completed by a different server. For instance, the server may identify that the processing of user login data has not yet been complete, and that the aforementioned processing step still remains pending. Then, based on a count of retries associated with the one or more steps satisfying a threshold, the server may identify one or more files associated with the one or more steps and may, based on determining that the one or more files are available, generate and store one or more lock marker files corresponding to the one or more files. For example, the server may note that the master table of login records is available because a lock marker file does not exist, then access that master file and generate its own lock marker file to prevent other servers from accessing the master file. The server may then perform the one or more steps by performing one or more processing actions on the one or more files and, based on determining that the one or more steps are complete, cause deletion of the one or more lock marker files and generate and store the job completion file corresponding to the batch job. For instance, and returning to the above example, the server may process the master table, generate an analysis file, then store the analysis file and delete the one or more lock marker files so as to indicate to other servers that both the master file and the analysis file are available for access.

In some cases, a batch job may be completed by different servers (e.g., in different regions) at different times. Along those lines, servers (e.g., in different regions) may be tasked with completing batch jobs (or steps of batch jobs) at different times so as to avoid conflict. For example, the queue of batch jobs may indicate both that the batch job is scheduled to be performed by the server at a first time and that that the batch job is scheduled to be performed by a second server at a second time. In such an example, the server may identify the one or more steps based on determining that the first time has occurred. Moreover, the server may be configured to identify the one or more steps of the plurality of steps to perform based on determining whether a second server in a different geographic region has performed one or more second steps. In this manner, one server might be able to complete an incomplete batch job started by one or more other servers.

As part of the process described above, retry counts may be monitored and retry limits may be implemented. For example, the server may determine the count of retries by identifying a history of performance of the one or more steps by one or more second servers. In such a circumstance, it may be desirable to prevent execution of a step based on determining that the number of retries exceeds some maximum number. For example, a server may avoid performing a step if it has been unsuccessfully retried by other servers five times because such continual failure may evidence some issue with the underlying data or process.

In general, a lock marker file might be used to identify circumstances when one or more files are in use, and a lock marker file may be generated when a server accesses a file such that it warns other servers to not access the file. One of the many advantages of that process described herein is that it might be agnostic to operating system and/or file system requirements. For example, the one or more lock marker files may effectively replace operating system and/or file system locks, meaning that a locked state of a file can be maintained even when one server might be incapable of recognizing that the file has been locked at an operating system level. With that said, operating system-level files might also be used. For example, as part of generating and storing one or more lock marker files, the server may generate an operating system file corresponding to the one or more files and store, in a folder corresponding to the one or more files, the operating system file. As another example, file system locks may be implemented in conjunction with lock marker files. Such a redundant approach might ensure that, for example, servers that might not be configured to identify lock marker files might nonetheless be inhibited from accessing the file.

The processing steps performed as part of a step of a batch job may comprise a wide variety of actions. For instance, and as alluded to above, steps may comprise accessing one or more files on one or more servers and performing some sort of action on those files (e.g., editing the file, generating new files based on those files). For instance, the one or more processing actions may comprise generating and storing a second file based on content of one or more files. This is one of the many reasons lock marker files may be important, as it ensures that files are protected from inadvertent simultaneous access and processing by multiple servers at once.

Corresponding methods, apparatus, systems, and non-transitory computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts a system comprising one or more servers.

FIG. 3 depicts a flow chart comprising steps which may be performed to manage execution of a multi-step batch job.

FIG. 4 depicts an example of a batch job.

FIG. 5 depicts examples of files that may be stored by a persistent location, such as a database or data store.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects described herein relate to managing execution of a multi-step batch job. Organizations may implement a variety of servers across different geographic regions as part of, for example, a cloud server schema. In such a circumstance, the organization may have various batch jobs (e.g., multi-step processing tasks) that need to be performed by a regular basis; however, those jobs need not necessarily be performed by a specific server. For example, an organization might regularly process stored customer data to generate insights, but the particular server(s) that perform that processing need not be specifically identified. Indeed, it may be preferable to set up the servers such that a wide variety of different servers could perform the task, as doing so might ensure continuity of service even if certain servers/regions fail. That said, this approach can cause trouble: since the servers are often differently configured (e.g., use different operating systems, different file systems, are located in different time zones, serve different purposes), there is a high likelihood that the servers conflict when trying to perform the same or similar batch jobs. For instance, two servers might try to perform the same step of a batch job at the same time, causing a file access conflict. As another example, a server might try to perform a step already repeatedly attempted and failed by another server, wasting computing resources due to (for instance) a bug or misconfiguration.

Given the above, sophisticated orchestration techniques are required to ensure the durability of such a workflow in a server system (e.g., an active-active system, whereby servers operate independently across multiple regions to simultaneously and independently process batch jobs) where applications run across various regions. Among other requirements for a system that remedies the issues described above, the system must abstract the complexity of state management at the job and step/task levels while also enabling smooth job or step/task triggering, account for source data arrival patterns fluctuations, and provide resilience via an active-active configuration.

To remedy the issues above, and many others, aspects described herein broadly relate to a system that can manage execution of a multi-step batch job using, among other things, unique files, retry tracking, and the like. Job completion files may be used to uniquely indicate the completion of a batch job in a file system. This approach may be different from conventional (e.g., database-based tracking) because it allows files to be located along with the data to be processed, meaning that server changes (e.g., moving the underlying data from one server to another, copying the data for redundancy) does not inadvertently cause re-performance of a batch job. Similarly, lock marker files (e.g., files indicating access, by a server, to a file) may be used. These files may be located alongside the files to which they correspond and may be used to indicate access, by a server, to a file. In this manner, files might be locked not only by a file system and/or operating system (both of which can be unreliable), but also using a file that can be recognized and respected by a wide variety of different servers. Relatedly, step and/or batch job retry tracking may be implemented so as to ensure that, even if a batch job and/or step is not complete, one server does not attempt to perform a process that another server tried and repeatedly failed to complete. One of the many advantages of this retry tracking is that it ensures that the inherent redundancy of a multi-region server infrastructure does not result in wasted resources (e.g., from every server trying and failing the same step of a batch job step). Many other concepts for serving this management process are described herein as well: for example, a unique batch job scheduling approach is described so as to lower the likelihood of redundancy and/or conflict between different servers.

As such, the aspects described herein provides at least thirteen different benefits. First, the solution described herein provides status management by abstracting status management at both the job and step/task levels. This is achieved using lock marker files, job completed marker files, and step success indicators. Second, the solution described herein provides for automated retries for failed steps/tasks, in part by monitoring whether a step and/or task needs to be resubmitted for a retry. Third, those retries may be limited, such that excessive retries of a step are prevented and excessive computing resources are not wasted. Fourth, the aspects described herein provide auditability for batch jobs and tasks, in part due to the storage of various files indicating processing of steps of a batch job, completion of the batch job, and the like. Fifth, the solution described herein provides observability of the performance of steps across a server infrastructure, in part due to the aforementioned files. Sixth, the solution described herein provides a triggering mechanism that allows for the triggering of batch job performance at different times (e.g., different servers executing different steps of batch jobs at different times), avoiding possible redundancy and/or file access conflicts. Seventh, the solution described herein provides for the re-running of steps as desired, such as when a previous step fails. Eighth, the solution described herein provides for the handling of uneven source data arrivals, as the scheduling of batch jobs and the flexibility with which different servers perform those batch jobs can adapt to a wide variety of data receipt circumstances. Ninth, the solution described herein provides for tasks to be selectively performed as desired, meaning that the same server need not perform all steps of a batch job, and that servers can be scheduled to perform different steps as desired. Tenth, the solution described herein provides order and dependency in the performance of steps of a task, as the solution provides for a way to iteratively perform sequential steps of a batch job without conflict. Eleventh, the solution described herein provides workflows defined as code, as steps can be defined programmatically and implemented in a queue and/or schedule. Twelfth, the solution described herein provides protection against regional failure, as the failure of one or more servers does not prevent other servers from continuing the processing of a batch job as needed. Thirteenth, and finally, the solution described herein provides for easy monitoring and alerting of tasks, as monitoring dashboards can easily track step/job performance based on the existence of various files in a persistent location (e.g., a database and/or data store).

Aspects described herein improve the functioning of computers by improving the manner in which various servers perform processing tasks. The problems described herein are unique to multi-server implementations; that is, unique to computing environments. Moreover, the solutions described herein (e.g., the use of files in addition to operating system and/or file system locks) are unique and exclusive to computing devices. As such, aspects described herein correspond to computer-implemented solutions to computer-specific problems, and have no human analogue.

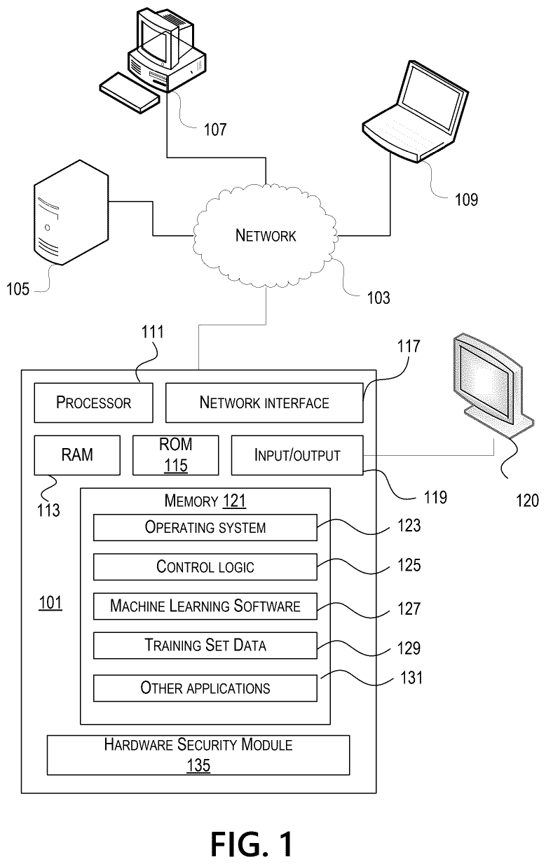

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Devices, such as devices 101, 105, 107, and/or 109, may additionally or alternatively comprise a hardware security module 135. For simplicity of explanation for the purposes of FIG. 1, the hardware security module 135 is shown as part of a device; however, the hardware security module 135 may be external to the devices (and, e.g., some module on a network). The hardware security module 135 may be configured to store one or more encryption algorithms, one or more keys (e.g., key encryption keys, data encryption keys), one or more passwords, or the like. The hardware security module 135 may be wholly or partially separated from other aspects of a computing device. For example, the hardware security module 135 may be accessible only in accordance with specific Application Programming Interfaces (APIs), via only specific programs, or the like. In this manner, the hardware security module 135 may be configured to securely manage processes such as encryption and decryption.

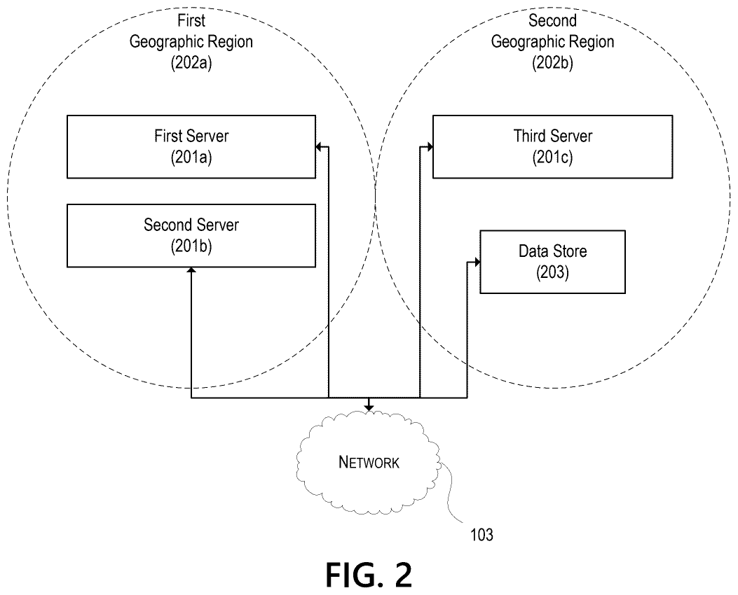

FIG. 2 depicts a system comprising a first geographic region 202a including a first server 201a and a second server 201b and a second geographic region 202b including a third server 201c and a data store 203, all connected via the network 103. The system depicted in FIG. 2 is illustrative, showing among other things how different servers and/or data stores might be located in different regions and might be communicatively connected in various ways. For example, the first server 201a may be located in the first geographic region 202a (which might be in the United States), whereas the third server 201c might be located in the second geographic region 202b (which might be in Asia). In turn, these differently-located devices might be communicatively coupled through the network 103, which might comprise all or portions of a public or private network.

Servers, such as the first server 201a, the second server 201b, and/or the third server 201c, may comprise one or more computing devices such as those described with respect to FIG. 1. The servers may be configured to perform various processing tasks as part of a batch job. For example, any one of the first server 201a, the second server 201b, and/or the third server 201c may be configured to perform one or more processing steps of a batch job by accessing and/or processing one or more files stored by the data store 203. The servers may implement one or more different operating systems and/or one or more different file systems. For example, the first server 201a may be part of one cloud infrastructure platform, whereas the second server 201b may be part of an entirely different cloud infrastructure platform. Indeed, one of the many benefits of the aspects described herein is that batch jobs may be performed by a wide variety of different servers (e.g., provided by different server providers, cloud server systems).

For the simplicity of explanation, servers, such as the first server 201a, the second server 201b, and/or the third server 201c, are described as communicating with one another and/or with respect to the data store 203 freely. With that said, various rules and/or permissions may be configured to enable such communications. For instance, the first server 201a and the third server 201c might be in different geographic regions (e.g., the first geographic region 202a and the second geographic region 202b) and might operate using different operating systems. In such a circumstance, various permissions may be set up and various services may be executed to facilitate interoperability between the two different servers.

The data store 203, an example of a persistent location, may be configured to store one or more files. Though only a single database is shown in FIG. 2, and though the database is shown as a separate element, a wide variety of databases may be implemented throughout the system: for example, as part of a server (e.g., a hard drive attached to the third server 201c), as a separate database (e.g., as part of a cloud storage platform), or the like. The data store 203 may store files in one or more directories and may permit servers to read, modify, and/or otherwise access those files, including create more files. For instance, when accessing a file stored by the data store 203, the second server 201b may generate and store, on the data store 203, a lock marker file that indicates access to the file. As another example, after a batch job is complete, the third server 201c may generate and store, on the data store 203, a job completion file. One advantage to this file-based process is that databases, such as the data store 203, may be replicated/duplicated/backed up in a manner that preserves information about access to files and the completion of batch jobs relating to files.

The data store 203 may additionally and/or alternatively comprise a database. While many of the examples provided herein relate to a file system on the data store 203 (and, e.g., the creation of files such as a lock marker file), a database might instead use one or more tables to store indications corresponding to such files. For example, a database much store a plurality of rows, each corresponding to one or more files, with a column of such a row configured to store an indication of whether the file is locked or unlocked. In such a circumstance, the column entry might operate similar to a lock marker file. Additionally and/or alternatively, a database might store information about jobs, including indications of whether one or more steps are complete, whether one or more jobs are complete, or the like.

In turn, for the purposes of this disclosure, persistent locations may correspond to either or both data stores (e.g., file storage systems) and databases (e.g., tabular databases, data lakes). Where one type of persistent location is described, other forms of persistent locations may be implemented as well. For example, data stores (e.g., storing data in files) may be replaced with a database (e.g., storing the data in tables), or vice versa.

As an example of how a batch job might be implemented in view of the system depicted in FIG. 2, the first server 201a may perform one or more first steps of a batch job by processing one or more first files stored by the data store 203. During that processing, one or more lock marker files may be generated and stored on the database such that other servers, such as the second server 201b and/or the third server 201c, are put on notice that the file is being accessed. Those one or more lock marker files may be deleted after the processing is complete. Later, the second server 201b and/or the third server 201c may complete the batch job by performing one or more second steps. Those one or more second steps may comprise processing one or more second files stored by the data store 203, which may be the same or similar to the one or more first files. As with the one or more first steps, this process may entail generating and storing one or more lock marker files for the one or more second files. Once the batch job is complete, a job completion file may be stored on the data store 203.

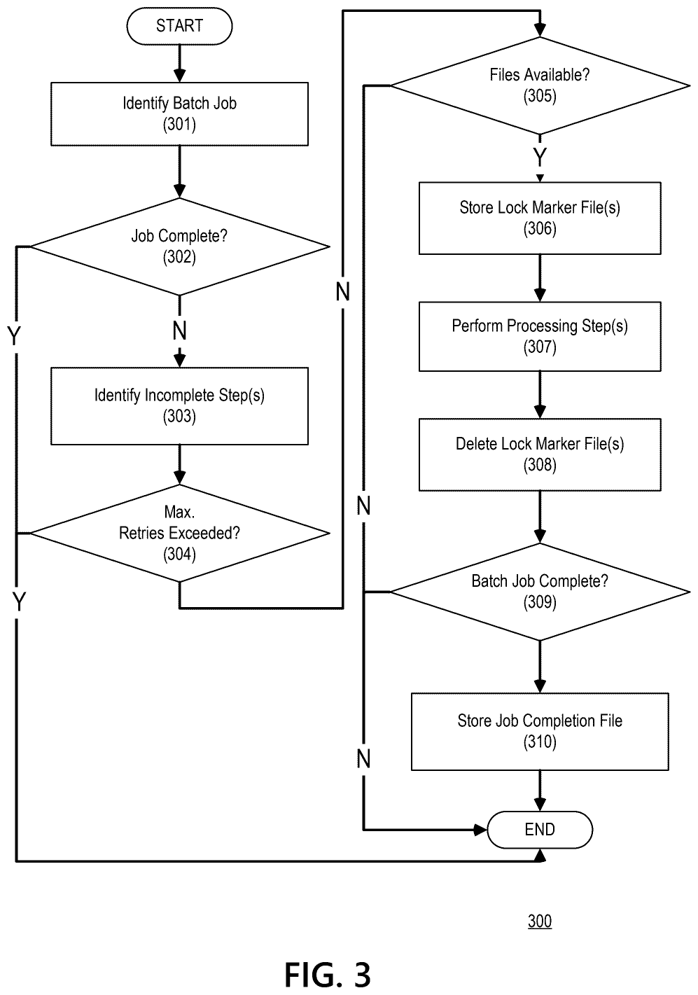

FIG. 3 depicts a flow chart depicting a method 300 comprising steps which may be performed by a computing device, such as the first server 201a, the second server 201b, and/or the third server 201c, for managing batch jobs. A computing device may comprise one or more processors and memory storing instructions that, when executed by the one or more processors, cause performance of one or more of the steps of FIG. 3. One or more non-transitory computer-readable media may store instructions that, when executed by one or more processors of a computing device, cause the computing device to perform one or more of the steps of FIG. 3. For simplicity, the steps below will be described as being performed by a single computing device such as a single server; however, this is merely for simplicity, and any of the below-referenced steps may be performed by a wide variety of computing devices, including multiple computing devices.

In step 301, a server may identify a batch job. A batch job may comprise any processing steps (e.g., with respect to one or more files), and might comprise one or more processing steps. The batch job might be identified based on a queue. For example, the server may identify, via a queue of batch jobs performable by a plurality of different servers that includes the server, a batch job comprising a plurality of steps. Batch jobs need not be completed by a specific server and/or by a specific series of servers. Rather, one advantage of such batch jobs as they might be completed, in whole or in part, by different servers without respect to region and/or server identity. With that said, as indicated previously, this flexibility can introduce issues with unnecessary duplication of efforts and/or file access conflicts, issues which are addressed by the aspects described herein.

The batch jobs may be specified by a queue of batch jobs that defines batch jobs and/or steps to be performed (e.g., on a periodic basis, upon the occurrence of certain conditions). The queue may specify that different servers perform a batch job at different times: for example, the queue of batch jobs may indicate that the batch job is scheduled to be performed by the server at a first time and that that the batch job is scheduled to be performed by a second server at a second time. In such an example, a server might identify one or more steps to perform based on determining that the first time has occurred. One advantage of this approach is that the schedule of certain steps and/or batch jobs might be configured such that unintentional redundancy and/or file access clashes are avoided. For instance, a first server might be configured to perform a batch job every 30 minutes and starting at 9:00 AM, whereas a second server might be configured to perform the same batch job every 30 minutes and starting at 9:15 AM. In this manner, the time each server initiates the batch job will be shifted by 15 minutes, potentially minimizing the possibility that either server needs to access the same file(s) at the same time.

Batch jobs may be completed by different servers, and different steps of a batch job may be completed by different servers. For example, the server might be located in a first geographic region, the batch job may be a multi-region batch job, and the server may identify the one or more steps of the plurality of steps to perform based on determining whether a second server in a different geographic region has performed one or more second steps. In this manner, servers might trade off responsibility between different steps of a batch job at different times. One advantage of this approach is that a single server need not complete all steps of a batch job, meaning that unexpected unavailability of that server does not require a complete restart of the batch job.

In step 302, the server may determine whether the batch job is complete. Batch job completion may be evidenced by a job completion file which may be stored alongside one or more files processed as part of the batch job. In turn, the server might determine that a particular batch job has been completed, even in circumstances where some form of central job tracking is not available, if it detects the presence of a job completion file. For example, the server may query a database to determine whether a job completion file corresponding to the batch job is stored on the database. If the batch job is not complete, the method 300 may proceed to step 303. Otherwise, the method 300 may end.

Job completion files may be in a variety of formats. For instance, the job completion file may be a simple as a file, stored on a database (and, e.g., alongside files processed as part of the batch job), that indicates (via title and/or contents) the completion of a batch job. Job completion files may additionally and/or alternatively comprise information such as the identity and/or identities of servers that completed one or more steps, the time(s) of the completion of such steps (and/or the time of the completion of the batch job), or the like. One advantage to using a file to store this information (in replacement of and/or in addition to storing such information in a database, such as in an event log) is that the job completion file may be stored alongside data and travel with that data. For example, if data in a database is duplicated to a redundant database, then the information indicating that certain files have already been processed as part of a batch job (that is, in this example, the job completion file) may also be copied and stored on the redundant database.

In step 303, the server may identify one or more incomplete steps. For example, the server may, based on determining that the job completion file corresponding to the batch job is not stored on the database, determine whether each of the plurality of steps have been completed.

In step 304, the server may determine whether a maximum number of retries has been met or exceeded. For example, the server may determine a count of retries associated with the one or more steps satisfying a threshold. A maximum number of retries for a batch job and/or steps of the batch job may be implemented so as to avoid unnecessary repetition of a batch job and/or steps of the batch job. After all, if one server has unsuccessfully tried to complete a step five times and has failed each time, then another similarly-configured server is also likely to fail, and attempts by that server are likely unnecessary until the processing/file issues are remedied. In turn, the server may be configured to identify circumstances where a threshold (e.g., maximum) number of retries has been satisfied (e.g., exceeded) and, if that threshold has been met, not perform the step(s). To determine this number of retries, the server may access a file indicating a number of retries and/or may process a file access history corresponding to one or more files to identify the number of retries. If the maximum number of retries has not been satisfied (e.g., exceeded), the method 300 may proceed to step 305. Otherwise, the method 300 may end.

The count of retries may be based on a history of performance of one or more steps by one or more servers. For example, the server may determine the count of retries by identifying a history of performance of the one or more steps by one or more second servers. The history of performance of one or more steps may be based on one or more files (e.g., a file indicating a history of performance of one or more steps and stored alongside the files to be processed during the step) and/or based on information in a database. For example, a log file may be stored alongside one or more other files on a database, and the log file may indicate a start time for a particular step of a batch job. If that log file indicates multiple starts of the same step of a batch job without a corresponding record of completion, then those multiple starts may be considered attempts at the step, and the count of retries may be based on those logged attempts.

In step 305, the server may determine whether one or more files are available. For example, the server may identify one or more files associated with the one or more steps and/or may determine whether the one or more files are available. Because there is a possibility that a server has already begun a step, determining whether the one or more files are available may, in some circumstances, help the server infer whether a step is currently being performed by another server. If the one or more files are available, the method 300 may proceed to step 306. Otherwise, the method 300 may end.

Determining whether the one or more files are available may be based on the presence or absence of a lock marker file. A lock marker file may be any file that indicates access, by one or more servers, to one or more files. In turn, the presence of a lock marker file may be used to indicate that one or more servers are accessing one or more files, whereas the absence of a lock marker file might be used to indicate that the one or more files are free to be accessed by a server. For example, the server may determine that the one or more files are available based on determining that the one or more lock marker files do not exist.

Alternative to and/or in addition to the use of a lock marker file, determining whether the one or more files are available may be based on operating system and/or file system information. Different operating systems and/or file systems may implement different ways to lock files. For example, some operating systems might purport to refuse to allow access to a file under certain circumstances (e.g., when providing edit access to the file to another computing device), whereas some file systems may implement a permissions system that includes a Boolean locked state for a file when it is being accessed by a computing device. In turn, and in part for desirable redundancy, these systems may be used in addition to and/or as an alternative to a lock marker file. For example, the server may determine that the one or more files are available further based on whether the one or more files are locked by a file system.

In step 306, the server may store one or more lock marker files. This storage may be based on determining that there are not any lock marker files yet—that is, because the files are free, the server may then add one or more lock marker files to indicate the server's intended use of those files as part of performing one or more steps of a batch job. For example, the server may generate and store one or more lock marker files corresponding to the one or more files. As part of generating and storing the one or more lock marker files, one or more operating system and/or one or more file system locks may be used. For example, the operating system may be configured to limit access to the one or more files to the server, and/or one or more file system locks may be used to prevent other servers from accessing the one or more files.

The one or more lock marker files may comprise an operating system file. Some operating systems might implement metadata and/or file information in the form of hidden files, meaning that the one or more lock marker files may be generated in a manner that (for example) hides the file from end users while simultaneously making the file available to other servers. For example, the server may generate an operating system file corresponding to the one or more files and store, in a folder corresponding to the one or more files, the operating system file.

In step 307, the server may perform one or more processing steps. The one or more processing steps may comprise one or more actions (e.g., reading, writing, editing, deleting, summarizing) one or more files. For example, the server may perform the one or more steps by performing one or more processing actions on the one or more files. Those processing actions may comprise, for example, causing the server to generate and store a second file (e.g., a thumbnail of an image) based on content of the one or more files (e.g., the original version of the image).

The server may be configured to implement automatic retries of steps when those steps fail (either during performance as part of step 307 and/or as part of previous performance by the same or a different server). For example, if the one or more processing steps indicated in step 307 fail, the server may be configured to retry those steps. In some circumstances, the server may be additionally and/or alternatively configured to also retry previous steps of a batch job as well, as those previous steps may have been poorly performed (leading to the failure of performance of a subsequent step).

During performance of one or more steps, a step region lock marker file may be generated and stored (e.g., in the database). Such a file may indicate that a step is currently being performed by a server. In turn, performance of that step by a server may be conditioned on the absence of such a file being stored on a database. In this manner, servers might be discouraged from performing redundant work (e.g., trying to finish the same step of the same batch job at the same time).

As part of performance of one or more steps, a step success file may be generated and stored. A step success file may indicate the completion of a step of a batch job, and may be stored alongside one or more files associated with the batch job. This step success file may be used to indicate to one or more other servers that a task has been performed.

In step 308, the server may delete the one or more lock marker files. Such a deletion may indicate completion of a step and may free up the one or more files corresponding to the one or more lock marker files for access by other servers. For example, the server may, based on determining that the one or more steps are complete, cause deletion of the one or more lock marker files.

In step 309, the server may determine whether the batch job is complete. Determining whether the batch job is complete may comprise evaluating whether all steps of the batch job are complete based on, for example, a lot of steps performed, the fact that the server completed the last step of a batch job, and/or based on a log of activity relating to the batch job. If the batch job is complete, the method 300 may proceed to step 310. Otherwise, the method 300 may end.

In step 310, the server may store a job completion file. The job completion file may be stored to indicate completion of the batch job and/or may be stored alongside one or more files associated with the batch job. For example, the server may, based on determining that all steps of the batch job are complete, generate and store the job completion file corresponding to the batch job.

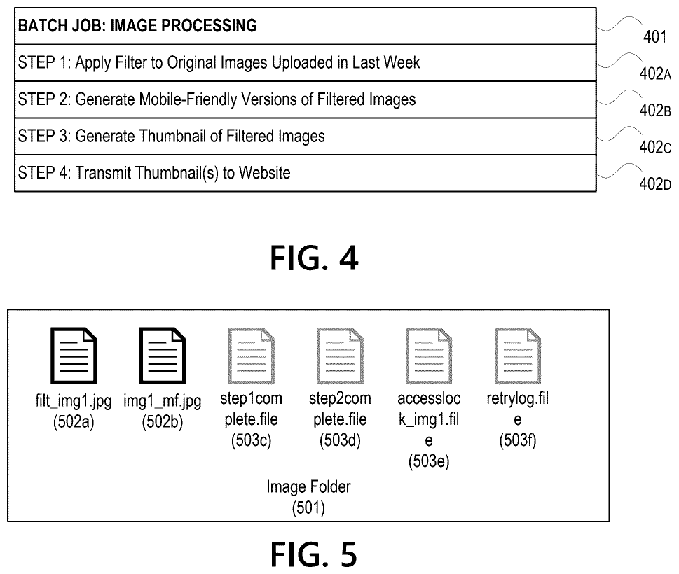

FIG. 4 shows an example of a batch job 401 for image processing. A first step 402a comprises applying a filter to original image(s) uploaded in the last week. A second step 402b comprises generating a mobile-friendly version of the filtered images. A third step 402c comprises generating thumbnails of the filtered images. A fourth step 402d comprises transmitting the thumbnails to a website. As illustrated by FIG. 4, many steps may be required to be completed in sequence, although not all steps need be completed in sequence. For example, the first step 402a must be completed before the second step 402b and the third step 402c, but the second step 402b need not be completed before the third step 402c. This means that, for example, the first step 402a may be performed by a first server, the second step 402b and the third step 402c may be performed by different servers at the same or different times, and the like.

FIG. 5 shows an example of an image folder 501 showing various files that might be stored as part of the batch job example from FIG. 4. Specifically, the image folder 501 comprises a filtered image file 502a and a mobile-friendly version of the image file 502b, suggesting that the first step 402a and the second step 402b have been performed already by a server. In turn, there are step success files in the image folder 501 reflecting this completion: specifically, a first step success file 503c that indicates that the first step has been completed and a second step success file 503d that indicates that the second step has been completed. Also shown in the image folder 501 is a lock marker file 503e indicating that the filtered image is being locked and a retry log file 503f indicating a history of attempts at one or more steps of the batch job.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A server configured to manage execution of a multi-step batch job, the server comprising:
one or more processors; and
memory storing instructions that, when executed by the one or more processors, cause the server to:
identify, via a queue of batch jobs performable by a plurality of different servers that includes the server, a batch job comprising a plurality of steps;
query a persistent location to determine whether a job completion file corresponding to the batch job is stored on the persistent location;
based on determining that the job completion file corresponding to the batch job is not stored on the persistent location, determine whether each of the plurality of steps have been completed;
based on determining that each of the plurality of steps have not been completed, identify one or more steps of the plurality of steps to perform;
based on a count of retries associated with the one or more steps satisfying a threshold, identify one or more files associated with the one or more steps;
based on determining that the one or more files are available, generate and store one or more lock marker files corresponding to the one or more files;
perform the one or more steps by performing one or more processing actions on the one or more files; and
based on determining that the one or more steps are complete:
cause deletion of the one or more lock marker files; and
generate and store the job completion file corresponding to the batch job.

2. The server of claim 1, wherein the queue of batch jobs indicates that the batch job is scheduled to be performed by the server at a first time, wherein the queue of batch jobs indicates that the batch job is scheduled to be performed by a second server at a second time, and wherein the instructions, when executed by the one or more processors, cause the server to identify the one or more steps based on determining that the first time has occurred.

3. The server of claim 1, wherein one or more second steps of the plurality of steps were previously performed by a different server.

4. The server of claim 1, wherein the instructions, when executed by the one or more processors, cause the server to determine the count of retries by identifying a history of performance of the one or more steps by one or more second servers.

5. The server of claim 1, wherein the instructions, when executed by the one or more processors, cause the server to generate and store the one or more lock marker files by causing the server to:
generate an operating system file corresponding to the one or more files; and
store, in a folder corresponding to the one or more files, the operating system file.

6. The server of claim 1, wherein the instructions, when executed by the one or more processors, cause the server to determine that the one or more files are available based on determining that the one or more lock marker files do not exist.

7. The server of claim 1, wherein the server is located in a first geographic region, and wherein the batch job comprises a multi-region batch job, and wherein the instructions, when executed by the one or more processors, cause the server to identify the one or more steps of the plurality of steps to perform based on determining whether a second server in a different geographic region has performed one or more second steps.

8. The server of claim 1, wherein the instructions, when executed by the one or more processors, cause the server to perform the one or more processing actions on the one or more files by causing the server to generate and store a second file based on content of the one or more files.

9. The server of claim 1, wherein the instructions, when executed by the one or more processors, cause the server to determine that the one or more files are available further based on whether the one or more files are locked by a file system.

10. The server of claim 1, wherein the instructions, when executed by the one or more processors, cause the server to determine the count of retries based on a file access history corresponding to the one or more files.

11. A method for managing execution of a multi-step batch job, the method comprising:
identifying, by a server and via a queue of batch jobs performable by a plurality of different servers that includes the server, a batch job comprising a plurality of steps;
querying, by the server, a persistent location to determine whether a job completion file corresponding to the batch job is stored on the persistent location;
based on determining that the job completion file corresponding to the batch job is not stored on the persistent location, determining, by the server, whether each of the plurality of steps have been completed;
based on determining that each of the plurality of steps have not been completed, identifying, by the server, one or more steps of the plurality of steps to perform;
based on a count of retries associated with the one or more steps satisfying a threshold, identifying, by the server, one or more files associated with the one or more steps;
based on determining that the one or more files are available, generating and storing one or more lock marker files corresponding to the one or more files;
performing, by the server, the one or more steps by performing one or more processing actions on the one or more files; and
based on determining that the one or more steps are complete:
causing, by the server, deletion of the one or more lock marker files; and
generating and storing the job completion file corresponding to the batch job.

12. The method of claim 11, wherein the queue of batch jobs indicates that the batch job is scheduled to be performed by the server at a first time, wherein the queue of batch jobs indicates that the batch job is scheduled to be performed by a second server at a second time, and wherein the identifying the one or more steps is based on determining that the first time has occurred.

13. The method of claim 11, wherein one or more second steps of the plurality of steps were previously performed by a different server.

14. The method of claim 11, wherein the determining the count of retries comprises identifying a history of performance of the one or more steps by one or more second servers.

15. The method of claim 11, wherein the generating and storing the one or more lock marker files comprises:
generating an operating system file corresponding to the one or more files; and
storing, in a folder corresponding to the one or more files, the operating system file.

16. One or more non-transitory computer-readable media storing instructions that, when executed by one or more processors of a server, cause the server to:
identify, via a queue of batch jobs performable by a plurality of different servers that includes the server, a batch job comprising a plurality of steps;
query a persistent location to determine whether a job completion file corresponding to the batch job is stored on the persistent location;
based on determining that the job completion file corresponding to the batch job is not stored on the persistent location, determine whether each of the plurality of steps have been completed;
based on determining that each of the plurality of steps have not been completed, identify one or more steps of the plurality of steps to perform;
based on a count of retries associated with the one or more steps satisfying a threshold, identify one or more files associated with the one or more steps;
based on determining that the one or more files are available, generate and store one or more lock marker files corresponding to the one or more files;
perform the one or more steps by performing one or more processing actions on the one or more files; and
based on determining that the one or more steps are complete:
cause deletion of the one or more lock marker files; and
generate and store the job completion file corresponding to the batch job.

17. The one or more non-transitory computer-readable media of claim 16, wherein the queue of batch jobs indicates that the batch job is scheduled to be performed by the server at a first time, wherein the queue of batch jobs indicates that the batch job is scheduled to be performed by a second server at a second time, and wherein the instructions, when executed by the one or more processors, cause the server to identify the one or more steps based on determining that the first time has occurred.

18. The one or more non-transitory computer-readable media of claim 16, wherein one or more second steps of the plurality of steps were previously performed by a different server.

19. The one or more non-transitory computer-readable media of claim 16, wherein the instructions, when executed by the one or more processors, cause the server to determine the count of retries by identifying a history of performance of the one or more steps by one or more second servers.

20. The one or more non-transitory computer-readable media of claim 16, wherein the instructions, when executed by the one or more processors, cause the server to generate and store the one or more lock marker files by causing the server to:
generate an operating system file corresponding to the one or more files; and
store, in a folder corresponding to the one or more files, the operating system file.
